(19) United States
(12) Patent Application Publication
(10) Pub. No.: US 2013/0054647 A1
(43) Pub. Date: Feb. 28, 2013

(54) INFORMATION PROCESSING APPARATUS, INFORMATION PROCESSING METHOD, AND PROGRAM

(71) Applicant: Daiki TERAUCHI, Tokyo (JP)

(72) Inventor: Daiki TERAUCHI, Tokyo (JP)

(21) Appl. No.: 13/555,637

(22) Filed: Jul. 23, 2012

(30) Foreign Application Priority Data
Aug. 25, 2011 (JP) 2011-183304

(51) Int. Cl. G06F 17/30

(52) U.S. Cl. 707/780; 707/E17.041

(57) ABSTRACT

Disclosed herein is an information processing apparatus including: a database configured to manage latitude/longitude information and a geohash as positional information about search objects; a generation block configured to generate a search reference point geohash indicative of a grid including a search reference point specified by latitude/longitude information; a setting block configured to set a primary search range at least including the grid represented by the generated search reference point geohash by use of a geohash and a secondary search range formed by a grid with the search reference point at the center thereof by use of latitude/longitude information; and a search block configured to search the primary search range for the search object and the secondary search range for the search object by referencing the database.

### BACKGROUND

The present disclosure relates to an information processing apparatus, an information processing method, and a program and, more particularly, an information processing apparatus, an information processing method, and a program that are configured to provide a user terminal with the information about other user terminals present around that user terminal.

A system is known in which, on the basis of longitude and latitude information supplied from a user terminal having a GPS (Global Positioning System) signal receiving function, a predetermined search range around this user terminal is searched for other user terminals and a search result thereof is provided (refer to Japanese Patent Laid-Open No. 2009-2131340 for example). With this system a distance between user terminals is computed by use of a difference between latitudes and longitudes.

### SUMMARY

As described above, the computation of the distance between user terminals by use of a difference between latitudes and longitudes is high in computation accuracy but at the expense of an increased computation amount. Therefore, if there are many search objects (namely, other user terminals) or higher search speeds are required, it is hardly the best to employ an approach based on the difference between latitudes and longitudes.

It should be noted that there is a method of representing user terminal positions by use of positional information known as a geohash system, in addition to the latitude/longitude difference approach. The geohash system is indicative of a grid on a map and is represented by an alphanumeric character string of several characters. As the number of characters increases, the size of a grid to be represented is reduced. Managing the positions of user terminals by use of this geohash system allows the search of user terminals to be faster than the use of the latitude/longitude approach.

However, because the geohash system is indicative of a grid rather than points on a map, the geohash system cannot indicate the position of each user terminal accurately. Therefore, use of the geohash system degrades searching accuracy as compared with the latitude/longitude approach.

Therefore, the present disclosure addresses the above-identified and other problems associated with related-art methods and apparatuses and solves the addressed problems by providing an information processing apparatus, an information processing method, and a program that are configured to search a predetermined search range for search objects at higher speeds and higher accuracy than the related-art technologies.

In carrying out the disclosure and according to one mode thereof, there is provided an information processing apparatus. This information processing apparatus has a database configured to manage latitude/longitude information and a geohash as positional information about search objects; a generation block configured to generate a search reference point geohash indicative of a grid including a search reference point specified by latitude/longitude information; a setting block configured to set a primary search range at least including the grid represented by the generated search reference point geohash by use of a geohash and a secondary search range formed by a grid with the search reference point at the center thereof by use of latitude/longitude information; and a search block configured to search the primary search range for the search object and the secondary search range for the search object by referencing the database.

The above-mentioned search block searches the primary search range for the search object by a prefix search of the geohash of the search object managed in the database and the search reference point geohash and the secondary search range for the search object by making a comparison between latitude/longitude information of the search object managed in the database and latitude/longitude information of the search reference point.

The above-mentioned setting block sets the primary search range by use of a geohash in accordance with a position of the search reference point in the grid represented by the generated search reference point geohash.

The above-mentioned setting block enlarges the primary search range by reducing the number of characters making up the geohash representing the primary search range in accordance with the number of the search objects to be searched from the primary search range by the search block.

The above-mentioned information processing apparatus further has an output block configured to compute a distance between the search object existing in the secondary search range and the search reference point and outputs the search object as a search result in accordance with a computed distance.

The above-mentioned information processing apparatus still further has a registration block configured to convert positional information of the search object specified by latitude/longitude information into the geohash to register the converted geohash into the database.

The above-mentioned database also manages icon information of the search objects.

In carrying out the disclosure and according to another mode thereof, there is provided an information processing method. This information processing method has: generating a search reference point geohash indicative of a grid including a search reference point specified by latitude/longitude information; setting a primary search range at least including the grid represented by the generated search reference point geohash by use of a geohash; searching the primary search range for the search object by referencing the database; setting a secondary search range formed by a grid with the search reference point at the center thereof by use of latitude/longitude information; and searching the secondary search range for the search object.

In carrying out the disclosure and according to still another mode thereof, there is provided a program for causing a computer to function as a database configured to manage latitude/longitude information and a geohash as positional information about search objects; a generation block configured to generate a search reference point geohash indicative of a grid including a search reference point specified by latitude/longitude information; a setting block configured to set a primary search range at least including the grid represented by the generated search reference point geohash by use of a geohash and a secondary search range formed by a grid with the search reference point at the center thereof by use of latitude/longitude information; and a search block configured to search the primary search range for the search object and the secondary search range for the search object by referencing the database.

In one mode of the present disclosure, a search reference point geohash indicative of a grid including a search reference point specified by latitude/longitude information is generated. A primary search range including at least the above-mentioned grid represented by the generated search reference point geohash is set by use of a geohash. The above-mentioned primary search range is searched for the above-mentioned search object by referencing a database that manages latitude/longitude information and geohashes as the positional information of search objects. In addition, a secondary search range made up of a grid with the above-mentioned search reference point at the center thereof is set by use of latitude/longitude information, thereby searching the above-mentioned secondary search range for the above-mentioned search object.

According to one mode of the present disclosure, search objects positioned in a predetermined search range can be searched for at high speeds and with enhanced precision.

### BRIEF DESCRIPTION OF THE DRAWINGS

FIG. 1 is a block diagram illustrating an exemplary configuration of a system that includes a search server to which an embodiment of the present disclosure is applied;

FIG. 2 is a diagram illustrating database registration items;

FIG. 3 is a block diagram illustrating an exemplary configuration of a search processing block;

FIG. 4 is a flowchart indicative of search processing;

FIG. 5 is a diagram describing reference point positions in a geohash grid;

FIGS. 6A, 6B, and 6C are diagrams illustrating search ranges corresponding to reference points in a geohash grid;

FIG. 7 is a diagram illustrating a display example of a search result in a user terminal; and

FIG. 8 is a block diagram illustrating an exemplary configuration of a computer.

### BRIEF DESCRIPTION OF THE PREFERRED EMBODIMENTS

This disclosure will be described in further detail by way of best modes (hereafter referred to as embodiments) thereof with reference to the accompanying drawings.

### (1) Embodiments

### Exemplary Configuration of Search Server

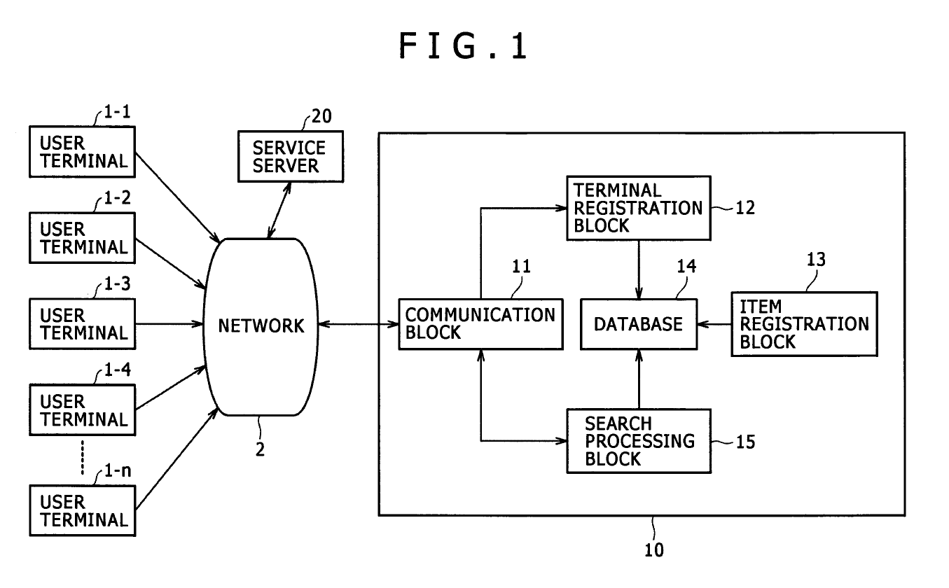

Now, referring to FIG. 1, there is shown an exemplary configuration of a system that includes a search server practiced as one embodiment of the disclosure. This search server 10 manages the positional information of many user terminals 1-i (i=1, 2, . . . n) and, upon a search request from a user terminal 1 (hereafter referred to as a user terminal 1A), searches a predetermined search range with the position of the user terminal 1A being a search reference point for other user terminals for example, supplying an obtained search result to the user terminal 1A. In what follows, the user terminals 1-i are simply referred to as a user terminal 1 unless otherwise specified.

The user terminal 1 has a GPS signal reception function and supplies the latitude/longitude that is the positional signal of the user terminal 1 based on a received GPS signal to the search server 10 along with the identification information of the user terminal 1 on a regular basis. In addition, in making the search server 10 search for another user terminal 1 for example, the user terminal 1 supplies the identification information, the positional information (latitude/longitude information) of the user terminal 1 as a search reference point, the number of requested search results, and a search request including a maximum search range around the user terminal 1 to the search server 10 via a network 2.

It should be noted that a service server 20 connected to the user terminal 1 may supply a search request to the search server 10 a network 2 instead of directly supplying a search request to the search server 10 from the user terminal 1 via the network 2. The service server 20 provides predetermined services (SNS (Social Networking Service), network gaming, and so on) to the user terminal 1.

The network 2 is the Internet, a mobile phone line network, or the like.

The search server 10 has a communication block 11, a terminal registration block 12, an item registration block 13, a database 14, and a search processing block 15.

The communication block 11 communicates with the user terminal 1 that routinely accesses the search server 10 via the network 2 to supply the identification information and the positional information (the latitude/longitude information) supplied from each user terminal 1 to the terminal registration block 12. In addition, the communication block 11 outputs a search request received from the user terminal 1A via the network 2 to the search processing block 15 and transmits a search result entered in response from the search processing block 15 to the user terminal 1A.

The terminal registration block 12 generates a geohash (made up of six characters for example) indicative of a grid of a predetermined size including a point indicated by the positional information (or the latitude/longitude information) of the user terminal 1 entered from the communication block 11, outputting the generated geohash to the database 14 along with the identification information, the latitude/longitude information, and so on.

The item registration block 13 virtually arranges in a real space items that can be used on a net game practiced on the user terminal 1, for example, outputting the identification information (the item ID), the latitude/longitude information, and the geohash of each item to the database 14. In addition, the item registration block 13 outputs the identification information (the point ID), the latitude/longitude information, and the geohash of each facility or store, for example, available for the user of the user terminal 1 to the database 14.

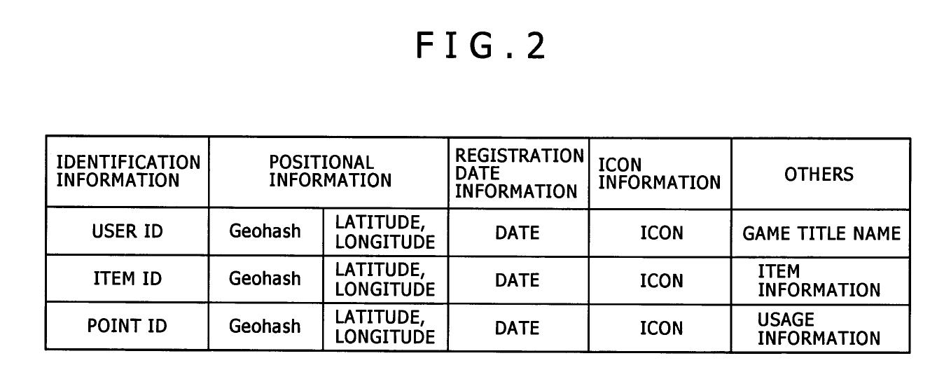

Referring to FIG. 2, there are shown the items of information to be registered in the database 14. To be more specific, the database 14 registers the geohash, latitude/longitude information and registration date information of each item as related with the user ID of the user terminal 1. In addition, the database 14 registers the geohash, latitude/longitude information and registration date information of each item as related with the item ID of each item entered from the item registration block 13. Further, the database 14 adds the geohash, latitude/longitude information and registration date information of each item to the point ID of such as a facility or a store for example and registers the resultant point ID. It should be noted that, in the database 14, given icon information and other information can be related with the user ID for example and registers these kinds of information. The icon information herein denotes may be the identification information of each icon or image data itself. If the icon information is the identification information of an icon and this icon is to be displayed on the user terminal 1, then the image data corresponding to the identification information of the icon is to be obtained from a predetermined server.

The search processing block 15 references the database 14 in response to a search request from the user terminal 1A entered from the communication block 11 to search a predetermined search range with the user terminal 1A used as a search reference point for other users 1, items, facilities, or stores, for example, thereby outputting an obtained search result to the communication block 11. It should be noted that, by arranging items to be searched for in each search request, the search objects may be limited only to other user terminals 1, only to items, only to stores, for example.

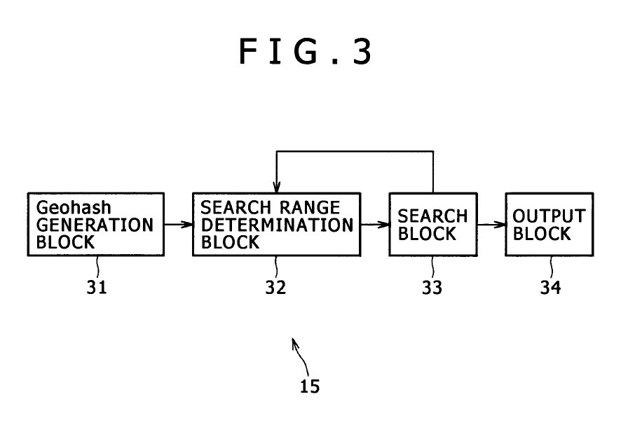

Referring to FIG. 3, there is shown an exemplary configuration of the search processing block 15. The search processing block 15 has a geohash generation block 31, a search range determination block 32, a search block 33, and an output block 34.

The geohash generation block 31 generates a geohash (a six-character geohash for example) indicative of a grid of a predetermined size including a search reference point by using, as a search reference point, the latitude/longitude of the user terminal 1A included in a search request transmitted by the user terminal 1A.

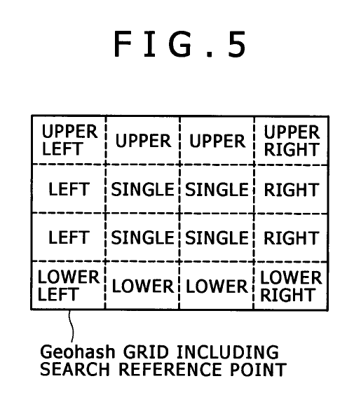

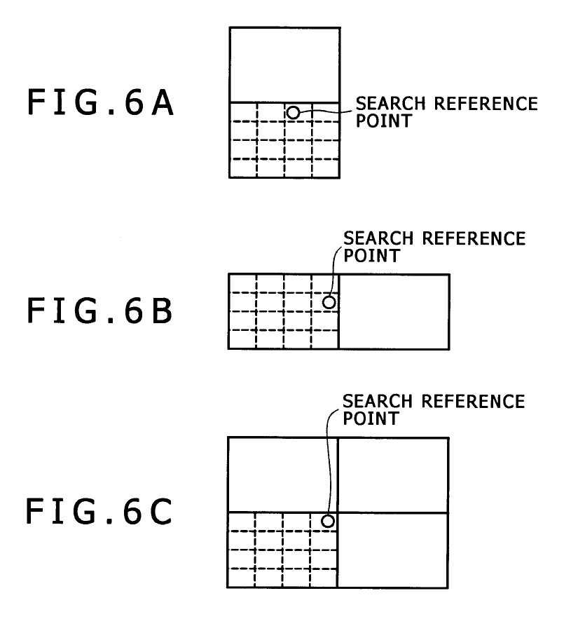

The search range determination block 32 determines a primary search range on the basis of the position of a search reference point in a grid (called a geohash grid) indicated by a geohash generated by the geohash generation block 31. The details of this determination will be described later with reference to FIG. 5 and FIGS. 6A to 6C.

In addition, the search range determination block 32 changes the primary search range by changing the size of a geohash grid that is a unit of the search range in accordance with the notification based on the number of search results of the primary search executed by the search block 33. Further, the search range determination block 32 determines, as a secondary search range, a square by use of the latitude and longitude having the same length as the short side of the geohash grid of the primary search range as the four sides of the square in accordance with a notification based on the number of search results of the secondary search executed by the search block 33. It should be noted that the secondary search range is not limited to a square; namely, the secondary search range may be rectangular.

The search block 33 references the database 14 to search the primary search range for a search object by the prefix search of a geohash of a geohash grid determined to be the primary search range in the primary search and a geohash of search objects (other user terminals 1 for example). In addition, the search block 33 references the database 14 to search the secondary search range for a search object by making a comparison between the square latitude/longitude that is the secondary search range in the secondary search and the latitude/longitude of a search object.

The output block 34 computes a distance between the user terminal 1A that transmitted the search request and a search object searched in the secondary search by the search block 33 on the basis of a difference between the latitudes/longitudes of the user terminal 1A and the search object, thereby outputting the computed distances by the number of request search results in the ascending order.

### Description of Operation

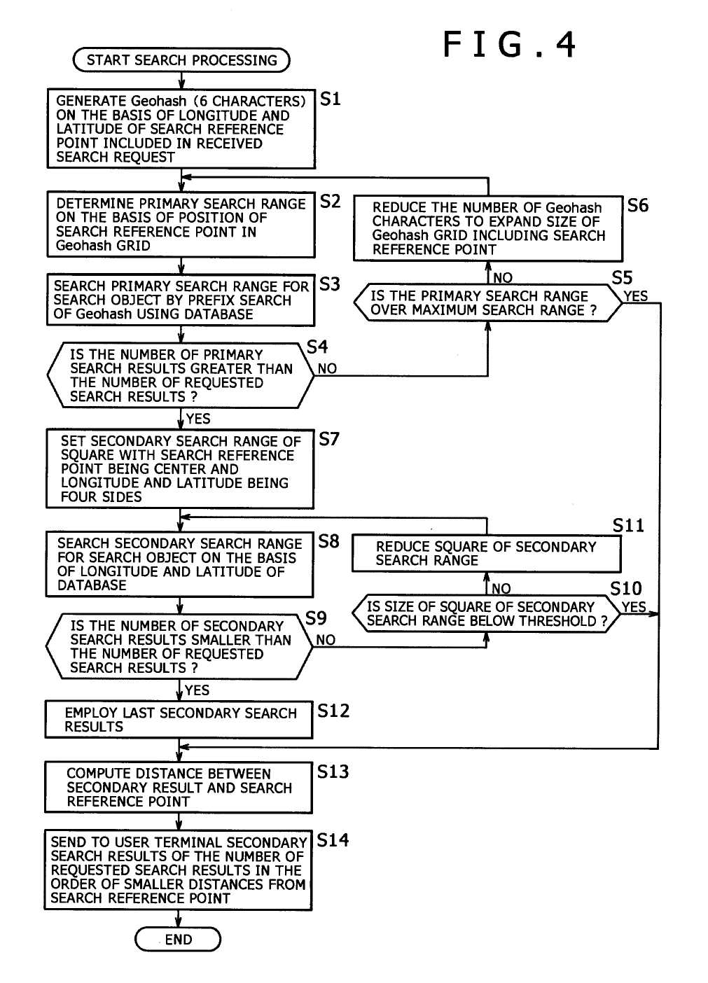

The following describes a search processing operation to be executed by the search server 10. Referring to FIG. 4, there is shown a flowchart indicative of the search processing operation.

In the following description, it is assumed that the positional information (the latitude/longitude information) regularly supplied from each user terminal 1 be registered in the database 14 of the search server 10. This search processing is started when a search request from a user terminal 1 is received.

In step S1, the communication block 11 outputs a received search request to the search processing block 15. In the search processing block 15, the geohash generation block 31 generates a geohash (made up of six characters) indicative of a grid of a maximum size providing an initial value, the geohash including a search reference point, the latitude/longitude of this user terminal 1 included in the search request being the search reference point.

In step S2, the search range determination block 32 determines the primary search range on the basis of the position of a search reference point in a geohash grid indicated by the geohash generated by the geohash generation block 31.

To be more specific, as shown in FIG. 5 for example, a geohash grid including a search reference point is divided by 16 to determine in which of the resultant areas the search reference point is included. Then, if the search reference point is included in one of the center areas indicated by “SINGLE” for example, only the geohash grid in which the search reference point is included is used as the search area.

In addition, as shown in FIG. 6A for example, if the search reference point is included in one of the areas indicated by “UPPER,” the geohash grid including the search reference point and a geohash grid adjacently thereon having the same size are used as search areas. Further, as shown in FIG. 6B for example, if the search reference point is included in one of the areas indicated by “RIGHT,” then the geohash grid including the search reference point and the geohash grid adjacently to the right thereof are used as the search area. If the search reference point is included in one of the areas indicated by “UPPER RIGHT” as shown in FIG. 6C for example, the geohash grid including the search reference point and the geohash grids adjacently upper, right, and upper right thereof having the same size are used as the search area.

When the primary search range is determined as described above, then, in step S3, the search block 33 references the database 14 to search the primary search area for a search object by the prefix search of the geohash of the geohash grid determined as the primary search area and the geohash of the search object (another user terminal 1 for example).

In step S4, the search block 33 determines whether the number of search results in the primary search is greater than the number of requested search results included in a search request from the user terminal 1A. If the number of search results in the primary search is found to be not greater than the number of search results, then the procedure goes to step S5. In step S5, the search range determination block 32 determines in accordance with the notification from the search block 33 whether the current primary search range is in excess of the maximum search range included in the search request from the user terminal 1A. If the current primary search range is found to be not in excess of the maximum search range, then the procedure goes to step S6.

In step S6, the search range determination block 32 reduces the number of characters of the geohash corresponding to the geohash grid including the search reference point, thereby enlarging the size of the geohash grid including the search reference point. Next, the procedure returns to step S2 to repeat the above-mentioned processing operations therefrom.

As described above, if the number of search results in the primary search is found to be greater than the number of requested search results in step S4 by enlarging the primary search range, then the procedure goes to step S7. In step S7, the search range determination block 32 determines the secondary search range that is square having the four sides of the lines of the same length as the short sides of the geohash grid forming the final primary search range, these short sides being parallel to the latitude or longitude with the search reference point at the center. However, if the latitude of this search reference point is extremely high, the grid with the latitude and longitude forming the four sides does not become correctly square, so that, in this case, the secondary search range is corrected such that a correct square is provided.

In step S8, the search block 33 references the database 14 to search the secondary search range for a search object by making a comparison between the latitude/longitude of the square forming the secondary search range and the latitude/longitude of the search object.

In step S9, the search block 33 determines whether the number of search results in the secondary search is smaller than the number of requested search results included in the search request from the user terminal 1A. If the number of search results in the secondary search is found not to be smaller than the number of requested search results, then the procedure goes to step S10. In step S10, the search range determination block 32 determines in accordance with the notification from the search block 33 whether the size of the square forming the current secondary search range is lower than a predetermined threshold value. If the size of the square is found to be not lower than the predetermined threshold value, then the procedure goes to step S11.

In step S11, the search range determination block 32 reduces the size of the square forming the secondary search range by a predetermined width. Then, the procedure is returned to step S8 to repeat the above-mentioned processing operations therefrom.

As described above, if the number of search results in the secondary search is found to be smaller than the number of requested search results as a result of the reduction of the secondary search range, then the procedure goes to step S12. In step S12, the search block 33 employs the last secondary search results, namely, a state in which the number of search results is slightly greater than the requested search results, as the secondary search results, outputting the employed secondary search results to the output block 34.

In step S13, the output block 34 computes the distance between each search object of the secondary search results and the user terminal 1A that transmitted the search request on the basis of the difference between the latitudes/longitudes thereof. In step S14, the output block 34 outputs the search objects of the number of requested search results in the ascending order of the distances from the user terminal 1A.

It should be noted that, if the current primary search range is found in step S5 to in excess of the maximum search range included in the search request from the user terminal 1A or if the size of the square that is the current secondary search range is found in step S10 to be below a predetermined threshold value, then the procedure goes to step S13. Thus the search processing executed by the search server 10 has been described.

As described above, according to the search processing executed by the search server 10, the primary search based on a geohash and the secondary search based on latitude/longitude information are executed stepwise, so that the search processing can be executed at high speeds and with enhanced precision at the same time.

### Exemplary Display of Search Results on User Terminal 1A

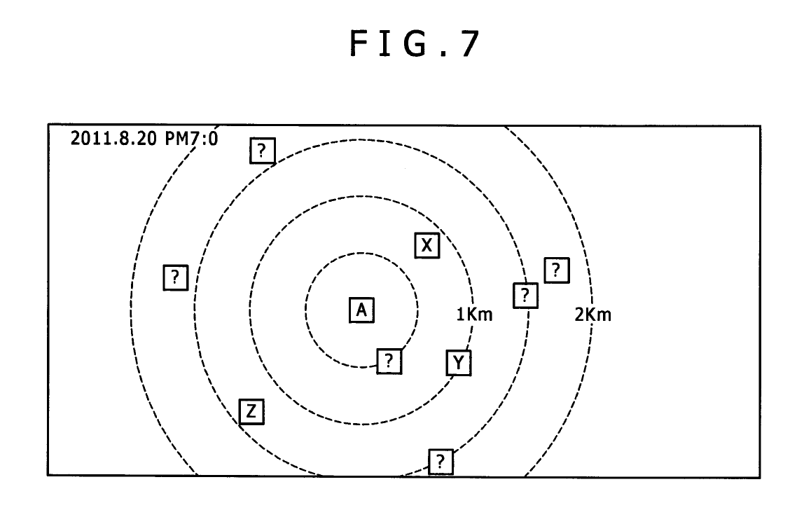

Referring to FIG. 7, there is shown an exemplary display of search results on the user terminal 1A that transmitted a search result.

As shown in FIG. 7, for example, a method is known in which icons corresponding to a search object (another user terminal 1 for example) as a search result are displayed concentrically around the user terminal 1A. These icons are displayed on the basis of given icon information registered in the database 14. For search objects with the icon information thereof not registered in the database 14, general-purpose icons (indicated by “?” in FIG. 9) are displayed.

In the example shown in FIG. 7, other user terminals 1X and 1Y exist within 1 km of the user terminal 1A and another user terminal 1Z exists within 1.5 km of the user terminal 1A. In addition, six search objects with the icon information thereof not registered exist within 2 km of the user terminal 1A.

It should be noted that the exemplary display shown in FIG. 7 is illustrative only; the displaying of search results on the user terminal 1A depends on an application program that executed the search request.

It should be noted that the above-mentioned sequence of processing operations may be executed by software as well as hardware. When the above-mentioned sequence of processing operations is executed by software, the programs constituting the software are installed in a computer which is built in dedicated hardware equipment or installed, from a network or recording media, into a general-purpose personal computer for example in which various programs may be installed for the execution of various functions.

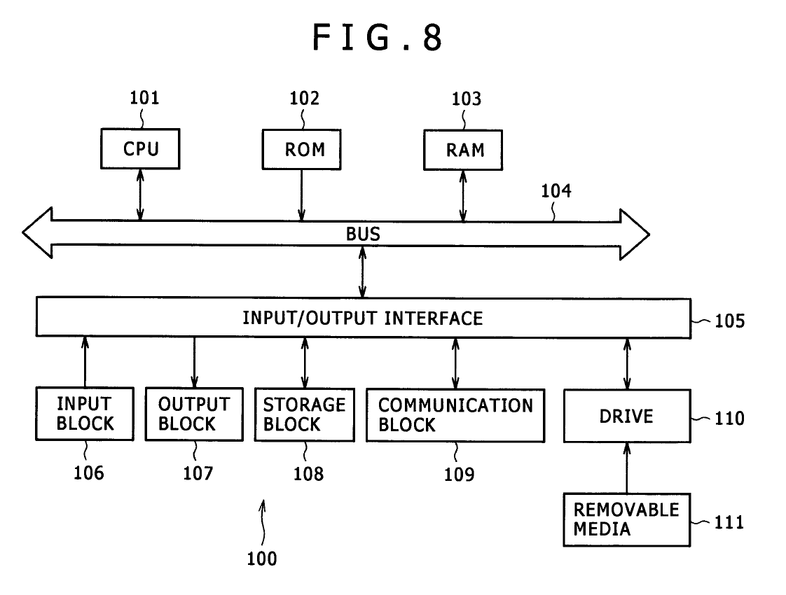

Referring to FIG. 8, there is shown a block diagram illustrating an exemplary configuration of the hardware of a computer that executes the above-mentioned sequence of processing operations by software programs.

In the computer, a CPU (Central Processing Unit) 101, a ROM (Read Only Memory) 102, and a RAM (Random Access Memory) 103 are interconnected by a bus 104.

The bus 104 is further connected to an input/output interface 105. The input/output interface 105 is connected to an input block 106, an output block 107, a storage block 108, a communication block 109, and a drive 110.

The input block 106 has a keyboard, a mouse, a microphone, and the like. The output block 107 has a display, a loudspeaker, and the like. The storage block 108 has a hard disk, nonvolatile memory, or the like. The communication block 109 is based on a network interface for example. The drive 110 drives a removable media 111 such as a magnetic disk, an optical disk, a magneto-optical disk, or a semiconductor memory.

In the computer configured as described above, the CPU 101 loads a program from the recording block 108 into the RAM 103 through the input/output interface 105 and the bus 104 and executes the loaded program, thereby executing the sequence of processing operations described above.

Programs to be executed by the computer (or the CPU 101) can be provided as recorded to the removable media 211 that is a package media for example. In addition, programs can be provided through the wired or wireless transmission media, such as a local area network, the Internet, or digital satellite broadcasting, for example.

In the above-mentioned computer, programs can be installed in the storage block 108 via the input/output interface 105 by loading the removable media 111 storing these computers onto the drive 110. In addition, program can be installed in the storage block 108 by receiving the programs via wired or wireless transmission media. Further, programs can be installed in the ROM 102 or the storage block 108 in advance.

It should be noted that programs to be executed by the computer may be processed in a time dependent manner along the sequence described herein or may be processed in parallel with each other or on an on-demand basis with necessary timing.

While preferred embodiments of the present disclosure have been described using specific terms, such description is for illustrative purpose only, and it is to be understood that changes and variations may be made without departing from the spirit or scope of the following claims.

The present disclosure contains subject matter related to that disclosed in Japanese Priority Patent Application JP 2011-183304 filed in the Japan Patent Office on Aug. 25, 2011, the entire content of which is hereby incorporated by reference.

What is claimed is:

1. An information processing apparatus comprising:
a database configured to manage latitude/longitude information and a geohash as positional information about search objects;
a generation block configured to generate a search reference point geohash indicative of a grid including a search reference point specified by latitude/longitude information;
a setting block configured to set a primary search range at least including said grid represented by the generated search reference point geohash by use of a geohash and a secondary search range formed by a grid with said search reference point at the center thereof by use of latitude/longitude information; and
a search block configured to search said primary search range for said search object and the secondary search range for said search object by referencing said database.

2. The information processing apparatus according to claim 1, wherein said search block searches said primary search range for said search object by a prefix search of said geohash of said search object managed in said database and said search reference point geohash and said secondary search range for said search object by making a comparison between latitude/longitude information of said search object managed in said database and latitude/longitude information of said search reference point.

3. The information processing apparatus according to claim 2, wherein
said setting block sets said primary search range by use of a geohash in accordance with a position of said search reference point in said grid represented by the generated search reference point geohash.

4. The information processing apparatus according to claim 2, wherein
said setting block enlarges said primary search range by reducing the number of characters making up said geohash representing said primary search range in accordance with the number of said search objects to be searched from said primary search range by said search block.

5. The information processing apparatus according to claim 2, further comprising:
an output block configured to compute a distance between said search object existing in said secondary search range and said search reference point and outputs said search object as a search result in accordance with a computed distance.

6. The information processing apparatus according to claim 2, further comprising:
a registration block configured to convert positional information of said search object specified by latitude/longitude information into said geohash to register the converted geohash into said database.

7. The information processing apparatus according to claim 2, wherein
said database also manages icon information of said search objects.

8. An information processing method comprising:
generating a search reference point geohash indicative of a grid including a search reference point specified by latitude/longitude information;
setting a primary search range at least including said grid represented by the generated search reference point geohash by use of a geohash;
searching said primary search range for said search object by referencing a database configured to manage latitude/longitude information and a geohash as positional information about search objects;
setting a secondary search range formed by a grid with said search reference point at the center thereof by use of latitude/longitude information; and
searching said secondary search range for said search object.

9. A program for causing a computer to function as
a database configured to manage latitude/longitude information and a geohash as positional information about search objects;
a generation block configured to generate a search reference point geohash indicative of a grid including a search reference point specified by latitude/longitude information;
a setting block configured to set a primary search range at least including said grid represented by the generated search reference point geohash by use of a geohash and a secondary search range formed by a grid with said search reference point at the center thereof by use of latitude/longitude information; and
a search block configured to search said primary search range for said search object and the secondary search range for said search object by referencing said database.
